(19) United States
(12) Patent Application Publication
(10) Pub. No.: US 2018/0075117 A1
(43) Pub. Date: Mar. 15, 2018

(54) SYSTEM AND METHOD OF PROVIDING A PLATFORM FOR ENABLING DRILL-DOWN ANALYSIS OF TABULAR DATA

(71) Applicant: Matthew E. Wong, New York, NY (US)

(72) Inventor: Matthew E. Wong, New York, NY (US)

(21) Appl. No.: 15/556,293

(22) PCT Filed: Mar. 15, 2016
(86) PCT No.: PCT/US16/22498

§ 371 Date: Sep. 6, 2017

Related U.S. Application Data
(60) Provisional application No. 62/134,261, filed on Mar. 17, 2015.

(51) Int. Cl. G06F 17/30; G06F 17/24

(52) U.S. Cl. CPC G06F 17/30572; G06F 17/247; G06F 17/246

(57) ABSTRACT

A method of providing a platform is disclosed for enabling drill-down analysis of tabular data, the method executing on one or more processors the steps of (a) receiving a first request to perform a first analysis on a data set of the tabular data; and (b) generating a first link between the data set and the first analysis, the link configured to be activated by a user to cause the first analysis to be performed on the data set, wherein the first link includes a first parameter associated with first drill down criteria to cause an analysis of a plurality of analyses to be performed on one or more data items of the data set that satisfy the first drill down criteria.

### CROSS-REFERENCE TO RELATED APPLICATIONS

This application claims priority to U.S. provisional application No. 62/134,261, filed Mar. 17, 2015, entitled System and Method of Providing a Platform For Enabling Drill-down Analysis of Tabular Data, which is incorporated by reference herein.

### FIELD OF THE INVENTION

The present invention relates to a system and method of providing a platform for enabling drill-down analysis of tabular data.

### BACKGROUND OF THE INVENTION

Today, large volumes of data are aggregated in the process of executing various business functions. Much of this data is tabular data created by numerous applications/sources such as spreadsheets, webpages, and databases. In many instances, a user may desire to run an analysis report on the tabular data to illustrate specific details on some or all of the tabular data. However, it becomes quite challenging to a user to analyze data in a top-down, exploratory manner in any great detail.

### SUMMARY OF THE INVENTION

Embodiments of a system and method are disclosed of providing a platform for enabling drill-down analysis of tabular data.

In accordance with an embodiment of the present disclosure, a method disclosed of providing a platform for enabling drill-down analysis of tabular data, the method executing on one or more processors the steps of: (a) receiving a first request to perform a first analysis on a data set of the tabular data; and (b) generating a first link between the data set and the first analysis, the link configured to be activated by a user to cause the first analysis to be performed on the data set, wherein the first link includes a first parameter associated with first drill down criteria to cause an analysis of a plurality of analyses to be performed on one or more data items of the data set that satisfy the first drill down criteria.

In accordance with another embodiment of the present disclosure, a method is disclosed of providing a platform for enabling drill-down analysis of tabular data, method executing on one or more processors the steps of: (a) receiving a first request to perform a first analysis on a data set of the tabular data; (b) generating a first link between the data set and the first analysis, the link being configured to be activated by a user to cause the first analysis to be performed on the data set, wherein the link includes a first parameter associated with first drill down criteria to cause the analysis of a plurality of analyses to be performed on one or more items of the data set that satisfy the first drill down criteria; and (c) performing, upon activation of the first link by a user, the analysis of the plurality of analyses on the one or more data items that satisfies the first drill down criteria.

In accordance with yet another embodiment of the present disclosure, a system is disclosed for providing a platform for enabling drill-down analysis of tabular data from a data source, the system comprising: (a) a data store to store the tabular data from the data source; and (b) one or more servers coupled to the data store and programmed to execute one or more modules, the modules comprising: (1) an analysis request event handler for generating a user request to perform a first analysis on a data set of the tabular data, wherein the request includes the data set to be analyzed, a link identifying the first analysis to be performed on the data set and a parameter associated with drill down criteria to be applied to one or more data items of the data set prior to the analysis; and (2) an analysis engine for (a) performing the a second analysis on the one or more data items that satisfies the drill down criteria and (b) outputting an analysis report of aggregated data based on the second analysis.

In yet another embodiment of the present disclosure, a method is disclosed of providing a platform for enabling drill-down analysis of tabular data, the method executing on one or more processors the steps of: (a) receiving a request to perform an analysis on a data set of the tabular data; and (b) generating a link between the data set and the analysis, the link configured to be activated by a user to cause the analysis to be performed on the data set, wherein the first link includes a first parameter associated with first drill down criteria to act as a filter on the data set for subsequent analysis.

### BRIEF DESCRIPTION OF THE DRAWINGS

FIG. 1 depicts a block diagram illustrating an example system in which a platform for enabling drill-down analysis of tabular data operates.

FIG. 2 depicts an enlarged block diagram of the central system in FIG. 1 wherein the platform for enabling drill-down analysis of tabular data is shown.

FIG. 3 depicts example method steps for implementing the platform for enabling drill-down analysis of tabular data.

FIG. 4-7 depicts example screen representations illustrating several method steps shown in FIG. 3.

FIG. 8 depicts a general-purpose computer to support the embodiments of the computer-implemented systems and methods including computer components disclosed in this application.

### DETAILED DESCRIPTION OF THE INVENTION

Embodiments of the present disclosure are described herein with reference to the drawing figures.

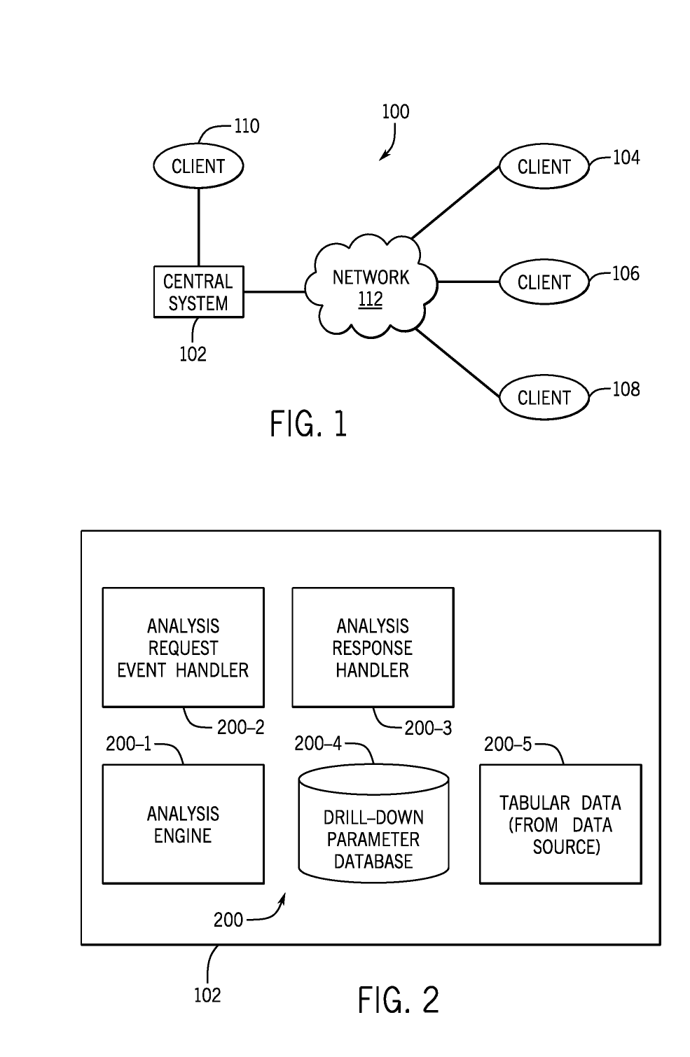

FIG. 1 depicts a block diagram illustrating an example system 100 in which platform 200 (described below) for enabling drill-down analysis of tabular data operates. In this embodiment, system 100 incorporates central system 102 that is connected to several clients 104, 106, 108, 110 via network 112 or directly as known to those skilled in the art. Network 112 may be the Internet, a local area network (LAN) and/or any other network as known to those skilled in the art. Clients 104, 106, 108, 110 may communicate with central system 102 over network 112 by cable, ISDN, WIFI or wireless carrier networks as known to those skilled in the art. (Data and information are used interchangeably in this disclosure unless otherwise noted.)

Each example client 100, 106, 108, 110 includes a personal computer and a monitor. However, clients 100, 106, 108, 110 may be smartphones, cellular telephones, tablets, PDAs, or other devices equipped with industry standard (e.g., HTML, HTTP etc.) browsers or any other application having wired (e.g., Ethernet) or wireless access (e.g., cellular, Bluetooth, IEEE 802.11b etc.) via networking (e.g., TCP/IP) to nearby and/or remote computers, peripherals, and appliances, etc. TCP/IP (transfer control protocol/Internet protocol) is the most common means of communication today between clients or between clients and central system 102 or other systems (i.e., one or more servers), each client having an internal TCP/IP/hardware protocol stack, where the “hardware” portion of the protocol stack could be Ethernet, Token Ring, Bluetooth, IEEE 802.IIb, or whatever software protocol is needed to facilitate the transfer of IP packets over a local area network.

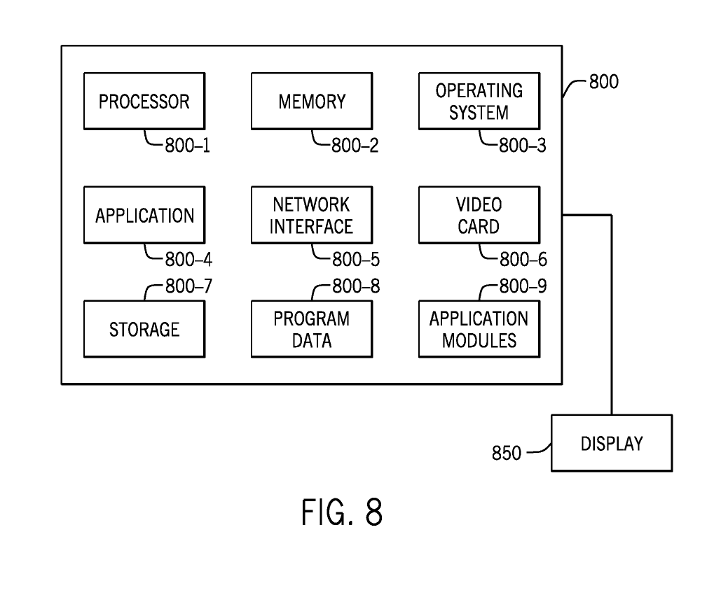

As described in more detail below, central system 102 includes one or more servers. The one or more servers may include a web server. Each server includes several internal components (e.g., processor, memory, drives, etc.), databases, software modules and applications (e.g., browser) as known to those skilled in the art. The server is an example of a general-purpose computer as shown in FIG. 8 and described below.

As shown in FIG. 2, central system 102 incorporates platform 200 for enabling drill-down analysis of tabular data. The tabular data to be analyzed is stored in a native or non-native electronic format such as a spreadsheet or other file (e.g., XLS, XLSX, CSV, TXT) that can be opened by any spreadsheet or database application known to those skilled in the art. Alternatively, the tabular data could be extracted from a database, webpage or network, and a spreadsheet application may merely act as a user interface for interacting with the data and related analyses. Examples of these spreadsheet applications include Microsoft Excel, Google Sheets, Kingsoft, Corel Quatrro Pro, Accel, Numbers, GS-Calc (to name a few).

In brief, platform 200 is a framework that enables a user to create an analysis report(s) of aggregated figures (i.e., aggregated data) displayed in a spreadsheet, wherein each aggregated figure within the report may then be acted upon (such as mouse-clicked) to create a subsequent analysis report (a “drill-down” analysis report) whose input is limited to that subset of data that corresponds to such acted-upon figure. (An aggregated figure or figures as used herein is an aggregation of one or more items of information/data (e.g., a row or more) of tabular data obtained from a spreadsheet or other data source described above. The figure may be a number, letter or other reference or symbol in a cell or part of a cell or one or more rows.) Platform 200 enables nesting of drill-down analyses that is not limited by the size or complexity of the drill-down criteria or level of nesting. Platform 200 also enables separation and independent (1) analysis functionality and (2) drill-down criteria so that the same set of instructions can support the analysis of any permutation without having to prepare any analysis in advance, of a user-defined dataset, analysis report and/or drill-down criteria. Platform 200 comprises one or more software applications, modules, computer instruction set and/or data from databases or other sources (as a data store) including analysis engine 200-1, analysis request event handler 200-2 analysis response handler 200-3, drill-down criteria database (DDPD) 200-4 and tabular data 200-5 (from a source such as spreadsheets). These modules/data of platform 200 may be implemented in one or more servers located locally or remotely across network 112. The modules/data are described in detail below.

Analysis engine 200-1 is the software application or module (or set of computer instructions) that receives requests for analysis (with or without drill-down), and in response, provides the analysis report (results). This module receives at least three inputs including 1) a particular analysis (i.e., particular aggregation report, such as “Quarterly Revenue by State”) requested by a user to run, 2) the raw data (or reference thereto) upon which the analysis is to be run, and 3) drill-down criteria, if any. Analysis engine 200-1 will extract a subset of raw data that meets/satisfies the drill-down criteria (or extract all of the raw data, if no drill-down input is present) as required to run the analysis (as described below) and output an analysis report that includes aggregated data and, for each drill-down enabled figure, a related drill-down criteria that may be used for further subsequent drill-down analysis requests. (The drill down criteria acts as a filter of the tabular data for subsequent analysis.) Aggregated data refers to an output of any level of aggregation, including a level of aggregation that may be so granular as to aggregate each input data item into its own unique group.

Analysis request event handler 200-2 is a software module (or set of computer instructions) that is executed when a user selects data to be analyzed (aggregated). The data may or may be subject to drill-down analysis (i.e., analysis on aggregated data generated by a prior analysis or more). Analysis request event handler 200-2 specifically creates the analysis request and sends it to analysis engine 200-1. Prior to creating and sending the request, if desired, analysis request event handler 200-2 may present a menu to a user to select which particular analysis report to generate. However, selection may be made in other ways known to those skilled in the art. To create the request, the event handler 200-2 will draw information from 1) a link such as a hyperlink, if any, associated with the triggered event (e.g., click on a link), and 2) other information associated with the cell, if any, associated with the triggered event. This information will be used to create the request that is passed on to analysis engine 200-1.

In this context, the hyperlink information is a property of a cell (or its contents) in a spreadsheet. Upon a mouse click, key press or other user-initiated action taken on such cell, the activated hyperlink (URL) triggers or calls on an analysis request event handler 200-2 by way of a hyperlink event handler (part of application as known to those skilled in the art, e.g., Worksheet_FollowHyperlink used in Excel). The hyperlink event handler is a code that can access hyperlink or other related information (i.e., data to be analyzed, drill down criteria and/or reference to either or both) that the analysis response handler had associated with a figure that triggered the request. (More specifically, the information could be contained in the hyperlink text itself, or could be contained in other properties (such as a cell's comment property) of the cell to which the hyperlink belongs. Drill-down criteria is an expression or formula that may be stored in DDPD 200-4 (in which case each unique drill-down criteria will have a unique drill-down reference code or reference number). When applied to any underlying data item within a provided input data set, the expression or formula (which evaluates to either true or false) determines whether such underlying data item shall be included in the subset of total raw input data on which the requested analysis will be performed. A drill-down parameter may be the expression or formula or a reference to the expression or formula as known to those skilled in the art.

Analysis response handler 200-3 is a software module (or set of computer instructions or script) that receives and processes the response from analysis engine 200-1 and interacts with the spreadsheet program to set up the interface, display the analysis report (results) to a user and establish the hyperlinks for each displayed drill-down-enabled figure.

Drill-down parameter database (DDPD) 200-4 is used when the native drill-down criteria representation, for each cell desired to be drill-down enabled, exceeds any limit that the spreadsheet application may impose on the size of (amount of) hyperlink information that may be associated with any one hyperlink in the spreadsheet. For example, some or all versions of Microsoft Excel limit the size of any cell's hyperlink text to a preset number of characters. In this case, the drill-down criteria is stored in DDPD 200-4, the related reference code (or reference number) is passed from analysis engine 200-1 to analysis response handler 200-3 and in turn the reference code is incorporated into the hyperlink that is passed to the spreadsheet application. For any subsequent request, analysis engine 200-1, upon receiving a drill-down criteria reference code, de-references the code into the actual drill-down criteria using a lookup table known to those skilled in the art.

Tabular data 200-5 are data obtained from a data source such as a spreadsheet, database or other source as known to those skilled in the art. The data is typically obtained in the form of rows and columns (including as may be implicit in structured formats such as XML or JSON), such as from a spreadsheet, text, HTML or CSV file, or a database table.

Analysis engine 200-1, analysis request event handler 200-2 and analysis response handler 200-3 may each be a) a separate application, module or object or linked library, residing on the same server as or on different servers from the server on which the spreadsheet program is operating and with which the user is directly interacting, and/or b) a spreadsheet application extension (such as a “plug-in” for Microsoft Excel or OpenOffice, or a “Google API Script” for Google Sheets).

The operation is briefly described as follows. When a user requests a drill-down-enabled analysis (report), analysis engine 200-1 provides output which includes, for each drill-down enabled figure, information that can be used to determine the underlying data from which such figure was derived. This information is essentially the criteria applied to the underlying data set in order to determine the data that was used to calculate such figure's value (i.e., the value of the aggregated result that a user may now drilled down into).

For example, if a drill-down-enabled output figure (analyzed or aggregated data derived from one or more items of data) represents the revenue in the month of October from all stores located in Texas, the drill-down criteria will indicate that the underlying data set for that figure relates only to the month of October and the state of Texas. If the data's month and state information are referred to as “transactionMonth” and “transactionState” and if the embodiment is implemented to use syntax similar to that used for WWW queries, then the drill-down criteria might be embodied as “transactionMonth=10&transactionState=TX.” Furthermore, if the analysis in which such figure existed was itself the result of a drill-down analysis report. (For example, where “transactionCategory=5”), then the drill-down criteria used to generate such report must be included in such figure's drill-down criteria. (For example, the entire drill-down criteria for such figure might be “transactionMonth=10&transactionState=TX&category=5”).

The drill-down criteria corresponding to each figure in the analysis engine 200-1 output, or information from which such criteria can be derived, is assumed to be present in the analysis engine 200-1 output. Analysis response handler 200-3 then interacts with the spreadsheet program to present the resulting report to the user, and for each drill-down enabled figure, analysis response handler 200-3 builds a hyperlink that it then associates, through the spreadsheet program, with that figure or its containing cell. (For example, in Microsoft Excel, a figure of 1,000 with drill down criteria of transactionMonth=10&transactionState=TX&category=5 might be implemented in a cell by setting the cell's “Value” property to 1,000 and setting the cell's “Hyperlink” property to http://drilldown?transactionMonth=10&transactionState=TX&category=5).

Using a built-in event handler such as Worksheet_FollowHyperlink or Worksheet_KeyPress in Microsoft Excel, analysis request event handler 200-2 is invoked upon the event of any user action designated to trigger drill-down (such as, but not limited to, a mouse click or a key stroke), and handler 200-2 fetches the drill-down criteria from the active cell's hyperlink. In the event that DDPD 200-4 is needed (because of a spreadsheet program's limitations is hyperlink size), the drill-down parameter information that is provided by the analysis engine will be represented by an identification parameter or code (such as a reference number) that is stored in DDPD 200-4 and associated with drill-down criteria (via a look-up table) also stored in DDPD 200-4.

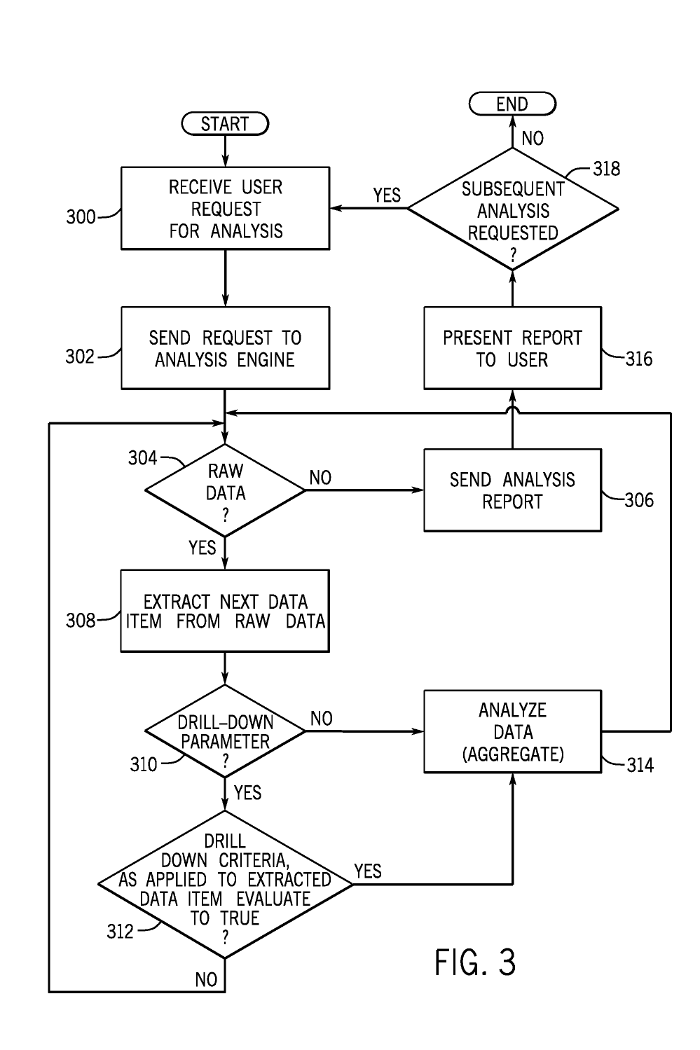

FIG. 3 depicts example method steps for implementing platform 200 for enabling drill-down analysis of tabular data. In particular, execution begins at step 300 wherein a user's request is received for analysis on data within one or more cells in a spreadsheet. Specifically, analysis request handler 200-2 may present the user with a menu of analysis options for selection. Alternatively, a user may enter an analysis request through other applications or directly via the spreadsheet program as known to those skilled in the art. Once the user selects an analysis option to run, the request is sent to analysis engine 200-1 at step 302. The request sent includes data, or a reference thereto, comprising the entire data set that is requested to be subject to the analysis request, along with a uniform resource locator (URL) indicating the analysis to be performed. The URL may also include a drill-down parameter to enable drill-down criteria to be applied to the data before the analysis is executed. That is, the drill-down parameter will enable a user to perform the analysis (i.e., cause the performance of) on the subset of data items of the data set.) The parameter may be the drill-down criteria itself, or may be a reference number or reference code that the analysis engine will use to look up (via a look-up table as known to those skilled in the art) the drill-down criteria stored in DDPD 200-4. If there is no drill-down parameter, drill-down analysis is not performed.

Execution proceeds to step 304 wherein it is determined if there are any raw data items that are part of the analysis request. Raw data items may not be present at this stage. For example, the data received may include column headers (e.g., “Name, Date, Balance”) with or without any rows of real data. Continuing the example, analysis request event handler 200-2 might receive data that consists of a single column with three rows including “Property,” “State,” “NY” and “CA,” but analysis request event handler 200-2 might not be configured to know whether the data consists of a header “Property” followed by three lines of body data (i.e., raw body data), a header of “Property State CA NY” followed by no body data, or some other combination of header rows and body data. Analysis request event handler 200-2 may merely pass data to analysis engine 200-1. If body data (i.e., raw data) is not present for subsequent processing at step 304, then execution proceeds to step 306 as described in more detail below.

If raw data items are present, execution proceeds to step 308 wherein analysis engine 200-1 extracts the next subject (unprocessed) data item from the raw data and then proceeds to decision step 310 wherein it is determined if a drill-down parameter is present in the analysis request information (such as the URL). If a drill-down parameter is present, it will be processed as described below with respect to step 312. If no drill-down parameter is present, then execution moves directly to step 314 wherein data will be analyzed by analysis engine 200-1.

Now, all extracted data is present at step 312, but if a drill-down parameter is present in the request, then only the data satisfying the drill-down criteria defined by the drill-down parameter, as evaluated at step 312, is passed on to analysis engine 200-1 for analysis at step 314. That is, for each data item to be analyzed (e.g. each row in a table of input data), if the drill-down criteria as applied to such item evaluates to true at decision step 312, or if no drill-down criteria was present in the request at decision step 302 (and queried at decision step 310), then execution moves to step 314 wherein such data item is analyzed and incorporated into the result as requested (That is, the data items are analyzed and consolidated (i.e., reduced) at step 314.) These data items are already in whatever standardized format that may be required by the analysis engine, as known to those skilled in the art.

Then execution returns to step 304 wherein it is determined if there are any more raw data items remaining for processing under the request. If yes, execution repeats again starting with step 308. If not, execution proceeds to step 306 wherein an analysis report is sent to analysis response handler 200-3 once the analysis engine completes the analysis. (At step 306, there may be some final formatting or processing of the report as known to those skilled in the art.) This analysis report (drill-down or non-drill-down) sent includes a series of analysis outputs, each of which includes one or more of the following (or information that can be used to derive the following): a) a value that resulted from the application of a function on zero or more of the input data items (for example, a sum, weighted average, rating, color code, or other numeric or non-numeric figure), b) a location on a two-dimensional display (or information used to derive a row and column), which may include row, column, or both (if location is not included, c) drill-down parameter specific to, but not necessarily unique to, this output, d) a handle or reference to the data source that was submitted in the request from which this output was created, and e) other information such as formatting instructions. This information could be sent in Extendible Markup Language (XML), Hypertext Markup Language (HTML), text, or other open or proprietary format, and enable analysis response handler 200-3 to populate specific cells with values from the analysis output, along with the data source handle (i.e., a reference or pointer) or reference and any related drill-down information in the cell's hyperlink (which in turn enables the user to click (to activate) to request a drill-down analysis (cause the performance of) on the subset of data that contributed to such cell's value). For example, in a drill-down analysis report (e.g. “Revenue in the U.S.”) applied to 50 data items, where an output value corresponds to a subset of only 10 out of those 50 data items (e.g. “Revenue in Nevada”), the hyperlink could enable the user to request, at the click of a mouse, a drill-down analysis as applied only to those 10 data items provided in the original analysis report. When clicked, analysis request event handler 200-2 will proceed as described above. (Note that the hyperlink/URL is one form of link used, but those skilled in the art know that a JSON file or any other link may be used in the embodiments disclosed herein.)

Execution then proceeds to step 316 wherein analysis response handler 200-3 presents the analysis report. In particular, handler 200-3 will read the outputs and transport hyperlink and data to the appropriate cells for display. In addition, it may perform other tasks such as applying formats. As indicated above, in the event that the drill-down parameter size could result in hyperlinks whose size exceeds the spreadsheet program hyperlink size allowance, then the drill-down criteria will be stored by the analysis engine in DDPD 102-4 (or other database) and the analysis output will include the related reference code or number in lieu of the actual hyperlink criteria.

At this point, the user will then have the option to execute further drill-down analysis at decision step 318. That is, with decision step 318, it is determined if a user requests a subsequent analysis. If yes, execution returns to step 300. The user may perform as many drill-down analyses (i.e., nested or un-nested aggregation analyses) as he/she desires on any prior analysis. If no addition request is received, then execution ends.

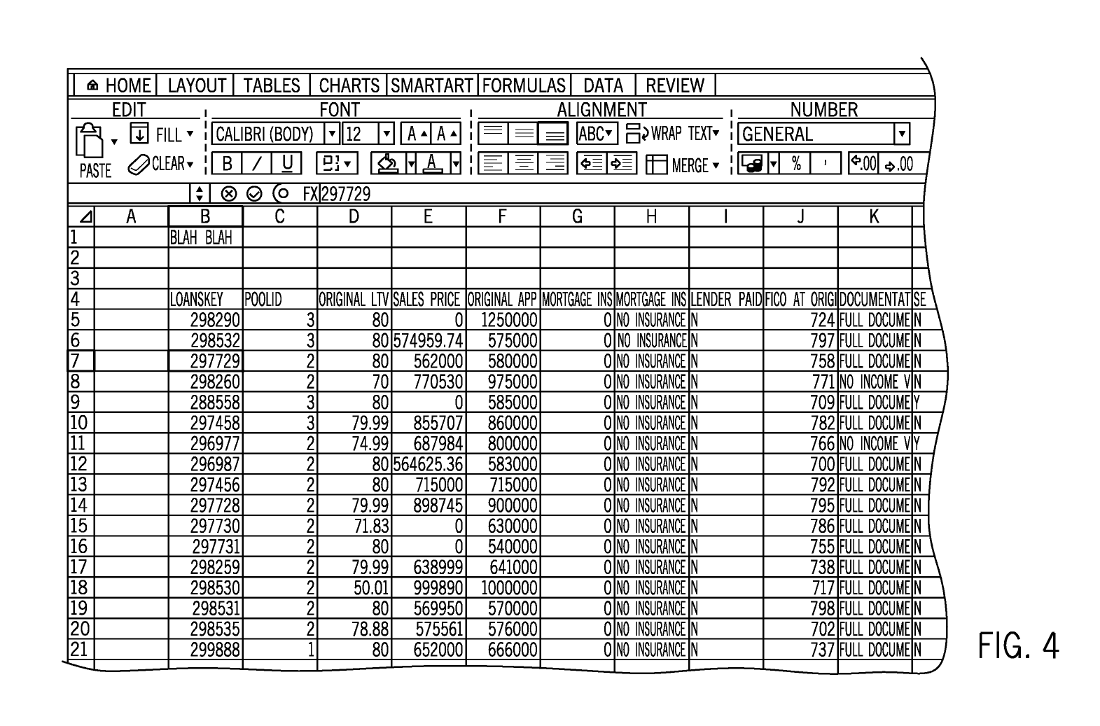

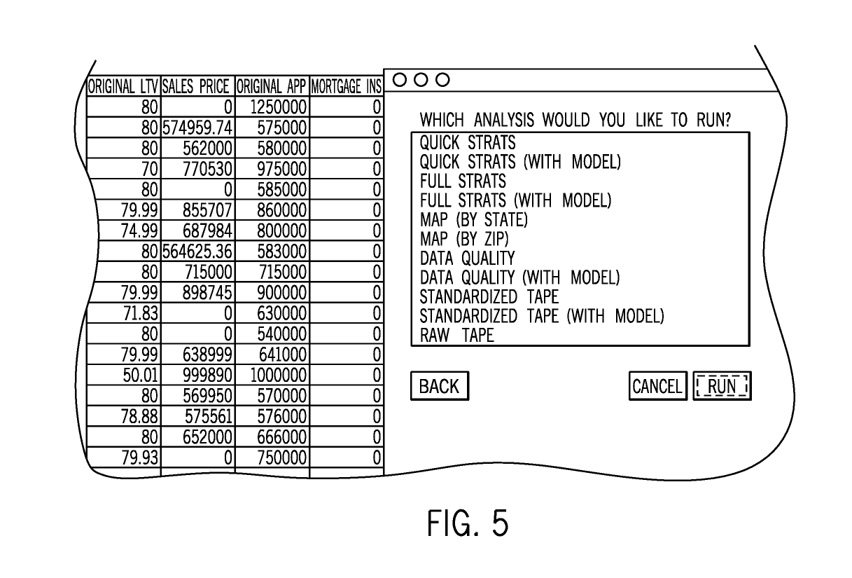

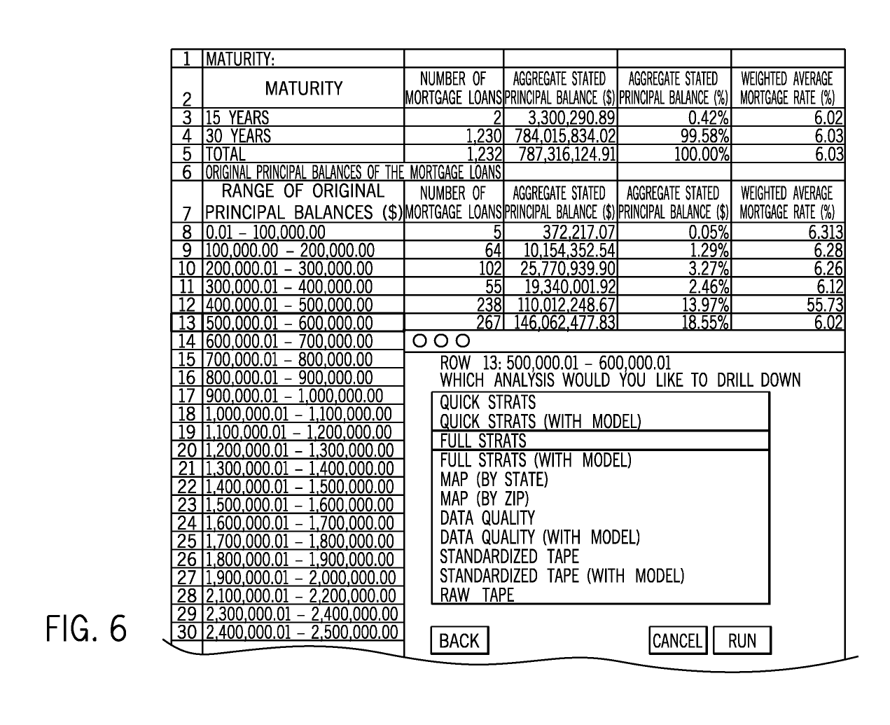

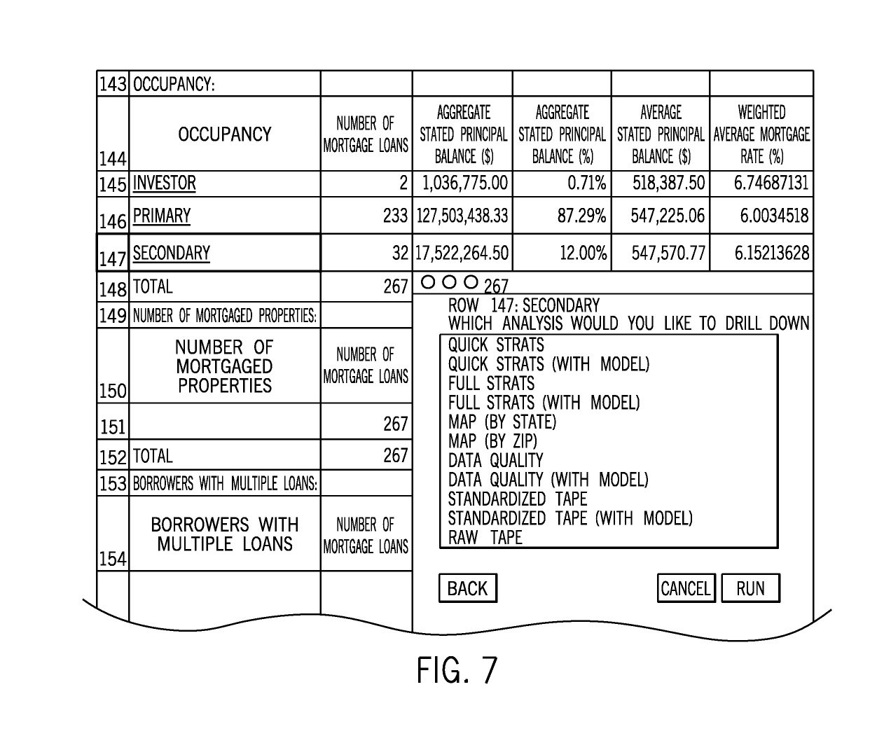

FIG. 4-7 depicts example screen representations illustrating several method steps shown in FIG. 3. In particular, FIG. 4 is a screen representation of an Excel spreadsheet depicting raw data in many cells (in rows and columns) of the spreadsheet. FIG. 5 is a screen representation of a section of the spreadsheet shown in FIG. 4 wherein a menu is presented to the user with several analysis options for the data. FIG. 6 is a screen representation depicting an analysis report (result) together with a drill-down menu (displayed upon user's mouse click on row 13. Here the user desires to perform drill-down analysis on the initial report.). In particular, the user has selected a drill down analysis Full Strats (full stratifications) to run on row 13. FIG. 7 is a screen representation of a drill-down analysis together with a nested drill-down menu. In particular, row 147 has been selected for further drill down analysis (but the particular drill down analysis has not yet been selected).

There are several alternative embodiments of this disclosure. These are described below.

In a first alternative embodiment, a user may open a spreadsheet that includes data within one or more cells. The user would then select specific data with desired cell(s) to analyze (run an analysis) by initially copying his or her data into a predefined file or template. The file or template may have certain analysis request event handlers and other code already embedded within it for processing and transmission. The data would then be sent to analysis engine 200-1 for analysis and an analysis report would be returned as described above for review.

In another embodiment, the input data set is not necessarily sent with each request. Instead of sending the input data, the analysis request may include a reference or handle to the input data that is to be used, and the analysis engine then derives the input data using such reference. Such reference may be generated by the analysis engine itself and returned in analysis output, in which case the analysis response handler may embed it in the displayed output's drill-down information. In yet another embodiment of this disclosure, instead of sending the raw data from the analysis request handler to the analysis engine, a reference to the data is sent (such as a file location or a database query definition), or, a coded reference to such reference is sent (e.g. instead the file name or database query definition is replaced with an alphanumeric code) and the data reference is obtained by looking up the related information in a lookup table. In any of these circumstances, platform 200 could, furthermore, store the data source information (whether the data itself, or a reference thereto) and the drill-down criteria information in DDPD 200-4 that is associated with a single reference code (or number). In this respect, a short reference numeral or symbol within the hyperlink will refer to or be associated with the combination of both the raw data (or reference thereto) and drill-down criteria. In doing so, the data (information) required to be stored in each drill-down enabled cell of a spreadsheet may be substantially reduced, and the data in the DDPD 200-4 may be substantially increased. (A lookup table will continue to be used to retrieve the desired analysis (e.g., formula) stored in DDPD 200-4 associated with the desired analysis.) Furthermore, the data source information can also be shortened via the same method employed by DDPD 200-4 (e.g., a database) that can convert the “long” information into a short code, such as a number, or visa versa).

In yet another embodiment of the disclosure, platform 200 employs a different analysis request event handler (than the specific one described above). For example, instead of using Worksheet_FollowHyperlink, which is triggered when the user clicks on a link in a cell and populates the cell's hyperlink value to enable the trigger, platform 200 may employ an event handler that would trap, for example, key presses or mouse clicks, and checks if the selected cell is drill-down enabled and proceeds to process the drill-down request.

The above alternative embodiments are not mutually exclusive, and can be combined in any manner.

FIG. 8 depicts a block diagram of general-purpose 800 computer to support the embodiments of the systems and methods disclosed herein. In a particular configuration, the computer 800 may be a server or a computer (client) as described above. The computer 800 typically includes at least one processor 800-1 and system memory 800-2 (e.g., volatile—RAM or non-volatile—Flash or ROM). System memory 800-2 may include computer readable media that is accessible to the processor 900-1. The memory 800-2 may also include instructions for processor 800-1, an operating system 800-3 and one or more application platforms 800-4 (e.g., Java) and a part or all of the software modules such as modules 800-9. The computer will include one or more communication connections such as network interfaces 800-5 to enable the computer to communication with other computers over a network, storage 800-7 such as a hard drives for storing data 800-8 and other software described above as well as program data 800-8, video card 800-6 and other conventional components known to those skilled in the art. This computer 800 typically runs Unix, Linux, Microsoft Windows, Macintosh OSX or any other operating system known to those skilled in the art. The operating system used includes a TCP/IP protocol stack (to communicate) for communication over the Internet as known to those skilled in the art. A display 850 is optionally used.

It is to be understood that the disclosure teaches examples of the illustrative embodiments and that many variations of the invention can easily be devised by those skilled in the art after reading this disclosure and that the scope of the present invention is to be determined by the claim(s) below.

What is claimed is:

1. A method of providing a platform for enabling drill-down analysis of tabular data, the method executing on one or more processors the steps of:
(a) receiving a first request to perform a first analysis on a data set of the tabular data; and
(b) generating a first link between the data set and the first analysis, the link configured to be activated by a user to cause the first analysis to be performed on the data set, wherein the first link includes a first parameter associated with first drill down criteria to cause an analysis of a plurality of analyses to be performed on one or more data items of the data set that satisfy the first drill down criteria.

2. The method of claim 1 wherein the method steps further comprising (c) performing, upon the first link activation by a user, the analysis of the plurality of analyses on the one or more data items that satisfies the first drill down criteria.

3. The method of claim 2 wherein the method steps further comprising (d) outputting a first analysis report of first aggregated data based on the analysis of the plurality of analyses of the one or more data items.

4. The method of claim 3 wherein the method steps further comprising:
(e) receiving a second request to perform a second analysis on the first aggregated data; and
(f) generating a second link between the first aggregated data and the second analysis, the second link configured to be activated by a user to cause the second analysis to be performed on the first aggregated data, wherein the second link includes a second parameter associated with second drill down criteria to cause another analysis of the plurality of analyses to be performed on one or more data items of the second aggregated data that satisfies the second drill down criteria.

5. The method of claim 4 wherein the method steps further comprising (g) performing, upon activation of the second link by a user, the another analysis of the plurality of analyses on the one or more data items of the first aggregated data that satisfies the second drill down criteria and (h) outputting a second analysis report of second aggregated data based on the another analysis of the plurality of analyses.

6. The method of claim 4 wherein the plurality of analyses includes the first analysis and the second analysis.

7. The method of claim 1 wherein the first link is a URL or JSON data representation.

8. The method of claim 1 wherein the first drill down criteria is a formula.

9. The method of claim 1 wherein the first parameter is the first drill down criteria or a reference code to the drill down criteria stored in a database.

10. A method of providing a platform for enabling drill-down analysis of tabular data, method executing on one or more processors the steps of:
(a) receiving a first request to perform a first analysis on a data set of the tabular data;
(b) generating a first link between the data set and the first analysis, the link being configured to be activated by a user to cause the first analysis to be performed on the data set, wherein the link includes a first parameter associated with first drill down criteria to cause an analysis of a plurality of analyses to be performed on one or more items of the data set that satisfy the first drill down criteria; and
(c) performing, upon activation of the first link by a user, the analysis of a plurality of analyses on the one or more data items that satisfies the first drill down criteria.

11. The method of claim 10 wherein the method steps further comprising (d) outputting a first analysis report of first aggregated data based on the analysis of a plurality of analyses of the one or more data items.

12. The method of claim 10 wherein the drill down criteria is a formula.

13. The method of claim 10 wherein the parameter is the drill down criteria or a reference code associated with the drill down criteria stored in a database.

14. The method of claim 11 wherein the method steps further comprising:
(e) receiving a second request to perform a second analysis on the first aggregated data; and
(f) generating a second link a first link between the data set and the first analysis, the second link configured to be activated by a user to cause the second analysis to be performed on the first aggregated data, wherein the second link includes a second parameter associated with second drill down criteria to cause another analysis of the plurality of analyses to be performed on one or more items of the data items of the second aggregated data that satisfies the second drill down criteria.

15. The method of claim 14 wherein the method steps further comprising (e) performing, upon the second link activation by a user, the another analysis of the plurality of analyses on the one or more data items that satisfies the second drill down criteria and (f) outputting a second analysis report of aggregated data based on the second analysis of the one or more data items.

16. The method of claim 10 wherein the plurality of analyses includes the first analysis and the second analysis.

17. A system for providing a platform for enabling drill-down analysis of tabular data from a data source, the system comprising:
(a) a data store to storing the tabular data from the data source; and
(b) one or more servers coupled to the data store and programmed to execute one or more modules, the modules comprising:
(1) an analysis request event handler for generating a user request to perform a first analysis on a data set of the tabular data, wherein the request includes the data set to be analyzed, a link identifying the first analysis to be performed on the data set and a parameter associated with first drill down criteria to be applied to one or more data items of the data set for the first analysis; and
(2) an analysis engine for (a) performing a second analysis on the one or more data items that satisfies second drill down criteria and (b) outputting an analysis report of aggregated data based on the second analysis.

18. The system of claim 17 wherein the modules further comprises (3) an analysis response handler for processing and displaying the report through the data source.

19. The system of claim 17 wherein the data source is a spreadsheet.

20. The system of claim 17 wherein the drill down criteria comprises a formula.

21. The system of claim 17 wherein the analysis engine is configured to extract the one or more data items from the data set.

22. The system of claim 17 wherein the first analysis and second analysis are the same and the first drill down criteria and second drill down criteria are different.

23. A method of providing a platform for enabling drill-down analysis of tabular data, the method executing on one or more processors the steps of:
(a) receiving a request to perform an analysis on a data set of the tabular data; and
(b) generating a link between the data set and the analysis, the link configured to be activated by a user to cause the analysis to be performed on the data set, wherein the link includes a parameter associated with drill down criteria to act as a filter on the data set for subsequent analysis.
